(19) United States
(12) Patent Application Publication
(10) Pub. No.: US 2007/0230719 A1
(43) Pub. Date: Oct. 4, 2007

(54) Efficient production of mechanical sound vibration

(76) Inventors: Andrew S. Filo, Cupertino, CA (US); David G. Capper, Novato, CA (US)

Correspondence Address: HAVERSTOCK & OWENS LLP, 162 N WOLFE ROAD, SUNNYVALE, CA, 94086, US

(21) Appl. No.: 11/706,013

(22) Filed: Feb. 13, 2007

Related U.S. Application Data
(60) Provisional application No. 60/773,188, filed on Feb. 13, 2006.

(51) Int. Cl. H04R 25/00; H04R 9/06; G08B 3/00

(52) U.S. Cl. 381/150; 381/414; 340/398.1

(57) ABSTRACT

An efficient method and apparatus for converting audio signals into mechanical vibrations is disclosed, the apparatus comprising a simple transducer. The transducer forms a dynamic magnetic field in response to an electronic signal. The dynamic field causes a mass positioned within the field to vibrate. When the mass is contacted to a surface of a structure, sound emanates from the structure.

### CROSS REFERENCE TO RELATED APPLICATIONS

This application claims priority of Provisional Patent Application Ser. No. 60/773,188, filed Feb. 13, 2006 and entitled: MINIATURE, LOW-POWER TRANSDUCER FOR THE PRODUCTION OF SOUND IN A SECONDARY OBJECT. The Provisional Patent Application Ser. No. 60/773,188, filed Feb. 13, 2006 and entitled: MINIATURE, LOW-POWER TRANSDUCER FOR THE PRODUCTION OF SOUND IN A SECONDARY OBJECT is hereby incorporated by reference.

### FIELD OF THE INVENTION

This invention falls in the field of transducers. More specifically, the invention falls in the field of miniature, low power transducers for converting electronic signals into mechanical vibrations for reproduction as sound.

### BACKGROUND OF THE INVENTION

In current practice, kinetic energy in the form of vibration is perceptible to the human ear as sound and usually transferred in an open air environment by a loudspeaker. A common loudspeaker is shown in cross-section in FIG. 1. The traditional design includes a lightweight semi-rigid cone 10, a coil 11 of fine wire, usually copper, a circular magnet 12, and a rigid support structure 13. The coil 11, known as the voice coil is attached to the apex of the cone 10. A gap 14 is a small circular hole, slot or groove which allows the voice coil 11 and cone 10 to move back and forth. The coil 11 is oriented coaxially inside the gap 14. The gap 14 is established between a permanent magnet 12 and a center post 15, also known as a pole piece. The center post 15 and back-plate 16 are sometimes a single piece called the yoke. The magnetic field is most concentrated in the gap 14. One magnetic pole is outside the coil, and the other magnetic pole is inside the voice coil. In addition to these components, a dynamic speaker also includes a suspension system to keep the coil 11 centered and to make the speaker components return to a neutral point after moving. A typical suspension system includes the spider 17, also known as a damper, which is at the apex of the cone, often of “concertina” form; and the surround 18, also known as the bellows, which is usually made of rubber and affixed at the outer circumference of the cone 10. The parts are held together by a chassis or basket 19, also known as the frame. When an electrical signal is applied, a magnetic field is induced by the electric current in the coil which becomes an electromagnet.

The coil 11 and the permanent magnet 12 interact with magnetic force which causes the coil 11 and a semi-rigid cone 10 to vibrate and reproduce sound at the frequency of the applied electrical signal. When a multi-frequency signal is applied, the complex vibration results in reproduction of the applied signal as an audio signal.

As useful and popular as loudspeakers are, they are limited to vibrating air to create sound in an open environment. They cannot be used to vibrate a mass to create a sound because it would dampen the motion of the cone and cause the functionality to cease. Two common technologies in current practice designed to vibrate a mass to create a sound are magnetostrictive materials and piezoelectric actuators.

Magnetostrictive materials are broadly defined as materials that undergo a change in shape due to change in the magnetization state of the material. Nearly all ferromagnetic materials exhibit a change in shape resulting from magnetization change, but most are too small to be useful. The most commonly used magnetostrictive material in current practice is Terfenol-D. Terfenol-D is a magnetostrictive crystal that changes shape in the presence of a magnetic field. Sound generation and propagation by Terfenol-D is well understood but limited by the fact that the transducers are relatively large, described as the size of a computer mouse. Terfenol-D transducers are not directly compatible with consumer electronic audio signals requiring conditioning circuits and batteries. Because only low current is needed to drive these devices, they require up to several hundred volts. These devices also require intimate surface coupling to transfer sound. The preferred means of locating and mounting the Terfenol-D device is to bolt or suction-cup it to the surface to produce the sound. Some recent applications of Terfenol-D transducers configured to reproduce audio by moving a mass are home audio, where a user can configure such a transducer to transfer audio vibration into a wall, thereby using the wall as a speaker, and another is the use of such transducers coupled to storefront window displays, converting the window into a speaker. However, the size, power requirement, and mounting of such transducers prevent them from being used in portable, handheld applications. Furthermore, Terfenol-D shavings formed as byproducts of manufacturing are flammable and therefore dangerous.

FIG. 2 shows a typical Terfenlol-D actuator. A housing 20 comprises a connector 21 configured to receive an input signal 22. The input signal 22 is routed to a coil 23 that is wound around a Terfenol-D rod 24. Permanent magnets 25 set up a magnetic field to actuate the motion in the crystalline structure of the Terfenlol-D rod 24. As a signal 22 is applied, the magnetic field oscillates accordingly causing the rod 24 to expand and contract accordingly. If the signal 22 is an audio signal, the rod 24 will convert the signal 22 into mechanical vibration corresponding to the audio signal. The rod 24 is coupled to a preloaded spring 26 which transfers mechanical vibration to a slug 27. The slug can contact another mass, such as a wall or store window to act as an audio speaker. Alternatively, the slug can be coupled to a paper cone, which in turn can vibrate air to cause sound to be transferred in free air, similar to the operation of the loudspeaker described above.

The second main category of transducers configured to move a mass consists of piezoelectric actuators (PZT). Piezoelectricity is the ability of crystals and certain ceramic materials to generate a voltage in response to applied mechanical stress, or in the alternative, the ability of crystals and certain ceramic materials to generate motion in response to an applied voltage signal. In contrast to magnetostrictive transducers described above, such vibration can be achieved with low voltages, on the order of a dozen volts. PZTs can be made far smaller than loudspeakers or magnetostrictive actuators, and can weigh as little as two grams. Furthermore, PZTs can be made from a large variety of crystals, such as tourmaline, quartz, topaz, cane sugar, and Rochelle salt, many other materials exhibit the effect, including quartz analogue crystals like berlinite (AlPO₄) and gallium orthophosphate (GaPO₄), ceramics with perovskite or tungsten-bronze structures (BaTiO₃, SrTiO₃, Pb(ZrTi)O₃, KNbO₃, LiNbO₃, LiTaO₃, BiFeO₃, NaₓWO₃, Ba₂NaNb₅O₅, Pb₂KNb₅O₁₅). Such transducers can also be made small and portable. Many current applications use PZT as cell phone ringers and various single tone generators. Although required voltages to drive a PZT are smaller than magnetostrictive actuators, the required voltage is still in the order of 10-20V, requiring either a large output battery which hinders portability or, alternatively, a DC-DC converter which uses a large amount of current, on the order of an ampere, which in turn can dramatically shorten battery life. Furthermore, since most piezoelectric crystals are ceramics, they are hard, but very brittle. Small amounts of force can permanently damage or destroy a PZT.

A typical PZT speaker is shown in FIG. 3. An input signal is applied to the terminals 30, one positive and one negative. The terminals are in electronic communication with an piezoelectric crystal. Usually, the crystal is multiple layers to enhance the piezoelectric effect. A bisected side view is shown in FIG. 3A. The crystal 31 is usually coupled to a film 32. A small applied signal causes the piezoelectric crystal to bend, expand and contract, which in turn causes the film 32 larger expansion and contraction. This is known as mechanical amplification. If the applied signal is an audio signal, the film 32 acts to vibrate air molecules around it causing sound to be transferred through open air.

Two main drawbacks plague PZTs. First, PZTs are very poor conductors of kinetic energy into a mass. The aspect ratios of crystalline movement are on the order of 1:1.2 and therefore any dampening by contacting a mass can severely restrict energy transfer, and thereby sound transfer. The second and more critical drawback to PZTs in audio applications is that their frequency response is not flat across the audio band. As seen in FIG. 3B, the response is highly nonlinear from 100-1000 Hz, which encompasses the bass range to the mid range of audio signals. Such a frequency response would result in uneven and unfaithful reproduction of audio signals. To correct such a response, filtering and gain circuitry would be needed, coming at the expense of battery life, complexity, and cost. For this purpose, PZTs are commonly used in buzzers, ringers, alarms, and other single tone applications. PZTs fall in a broader category of distributed mode actuators, or DMAs. While other materials exist to construct DMAs, all suffer the same inherent drawbacks which make them unsuitable to faithfully reproduce sound.

What is needed is a small transducer suitable for portable items, capable of being driven by a small voltage source such as a AA battery, while providing an accurate reproduction of audio signals to be efficiently transferred by mechanic vibration into a mass.

### SUMMARY OF THE INVENTION

A simple, low power transducer sufficiently small for portable applications and capable of faithfully reproducing audio signals as mechanical vibrations is disclosed. The transducer comprises a baseplate on which a ring magnet is mounted. The baseplate can be of any sturdy construction such as metal or plastic, including polycarbonate. Preferably, the baseplate is constructed of a magnetically saturable substance, such as a ferric metal. Preferably, a winding core is mounted on the baseplate substantially in the middle of the ring magnet. The transducer further preferably comprises a winding around the winding core. The winding preferably has positive and negative terminals to which electronic signals can be coupled. Alternatively, the terminals should be in electronic communication with a source of electronic signals. Preferably, the electronic signals are used to reproduce a desired sound, such as music. The transducer further preferably comprises a cylindrical casing coupled around the ring magnet and mounted to the baseplate. Preferably, a thin film is coupled to cap the cylindrical casing. The thin film is preferably a bendable material such as spring steel or polycarbonate. Alternatively, the thin film can be plastic, or any other material that can flex. Furthermore, a ferric slug is coupled to the thin film casing. As an electronic signal passes through the winding, a magnetic field is formed which corresponds to the electronic signal. The magnetic field interacts with the ferric slug, causing it to vibrate according to the electronic signal. When the slug comes in contact with a mass, it easily transfers the energy, in the form of mechanical vibration, into the mass.

### BRIEF DESCRIPTION OF THE SEVERAL VIEWS OF THE DRAWINGS

FIG. 1 shows a prior art loud speaker common in current practice.

FIG. 2 shows a prior art magnetostrictive actuator.

FIG. 3 shows a prior art piezoelectric speaker common in current practice.

FIG. 3A shows a prior piezoelectric speaker in bisected cross section.

FIG. 3B shows the frequency response of a prior art piezoelectric speaker.

FIG. 4 shows a cross section preferred embodiment of the simple low power transducer.

FIG. 4A shows the preferred embodiment at an angle.

FIG. 5 shows an application of the transducer in a pen.

FIG. 5A shows the pen in an embodiment of a holder having a resonant cavity.

FIG. 5B shows the pen in another embodiment of a holder having a suction cup.

FIG. 5C shows the pen having a casing.

FIG. 5D shows another embodiment of the casing as a standard 3 ring binder.

FIG. 5E shows another embodiment of the casing coupled to a backpack.

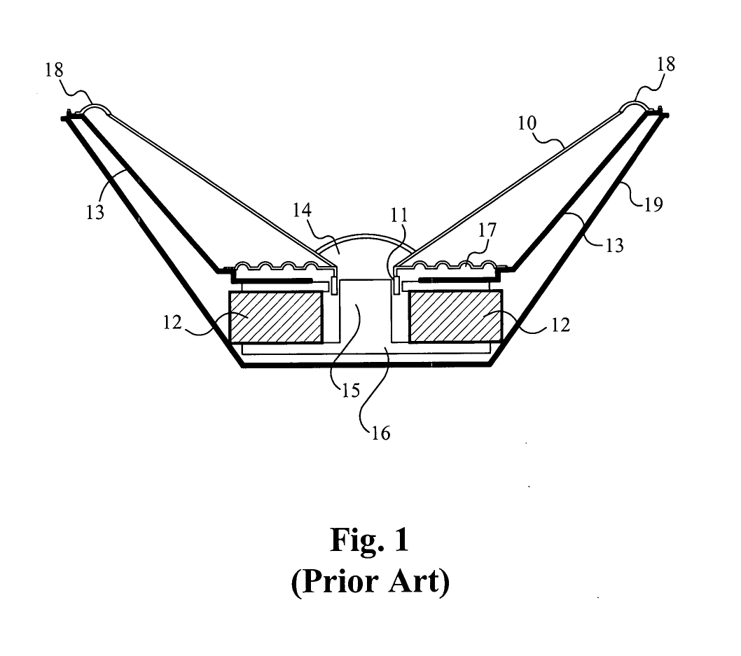

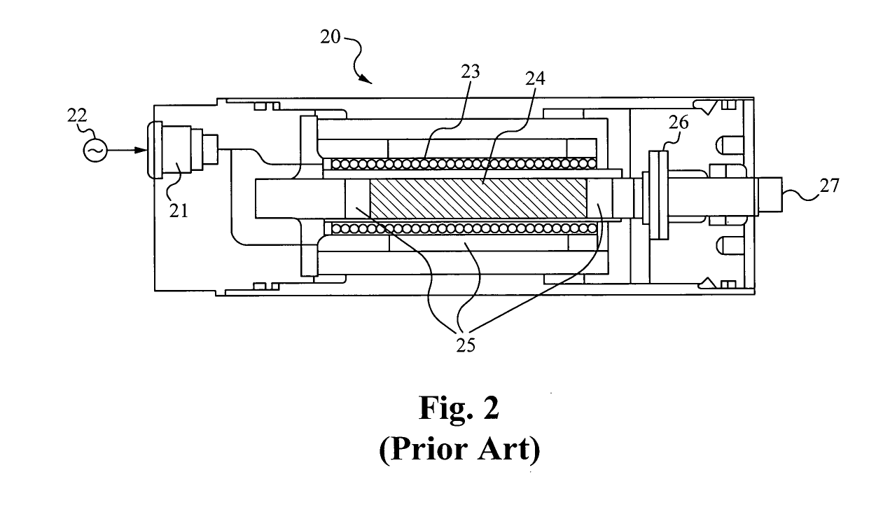

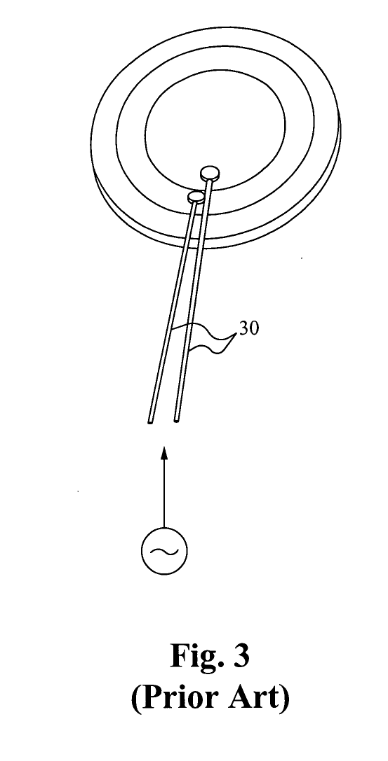

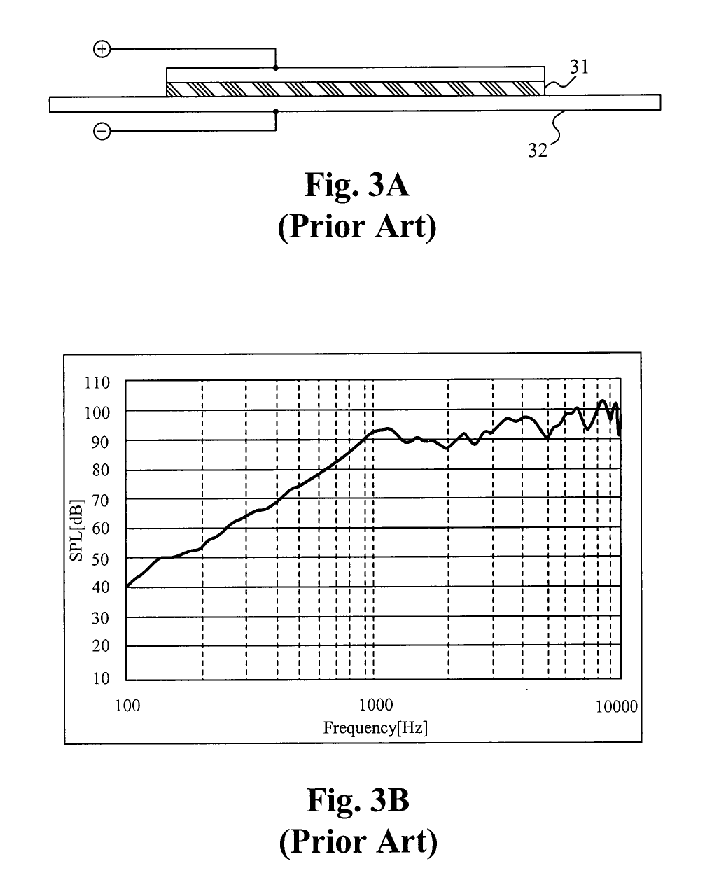

### DETAILED DESCRIPTION OF THE INVENTION

Embodiments of the present invention are directed to a method, apparatus, and example applications for efficiently converting an electronic signal into a mechanical vibration. Those of ordinary skill in the art will realize that the following detailed description of the present invention is illustrative only and is not intended to be in any way limiting. Other embodiments of the present invention will readily suggest themselves to such skilled persons having the benefit of this disclosure.

Reference will now be made in detail to implementations of the present invention as illustrated in the accompanying drawings. The same reference indicators will be used throughout the drawings and the following detailed description to refer to the same or like parts. It will, of course, be appreciated that in the development of any actual implementation, numerous implementation-specific decisions must be made in order to achieve the developer's specific goals, such as compliance with application and business related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

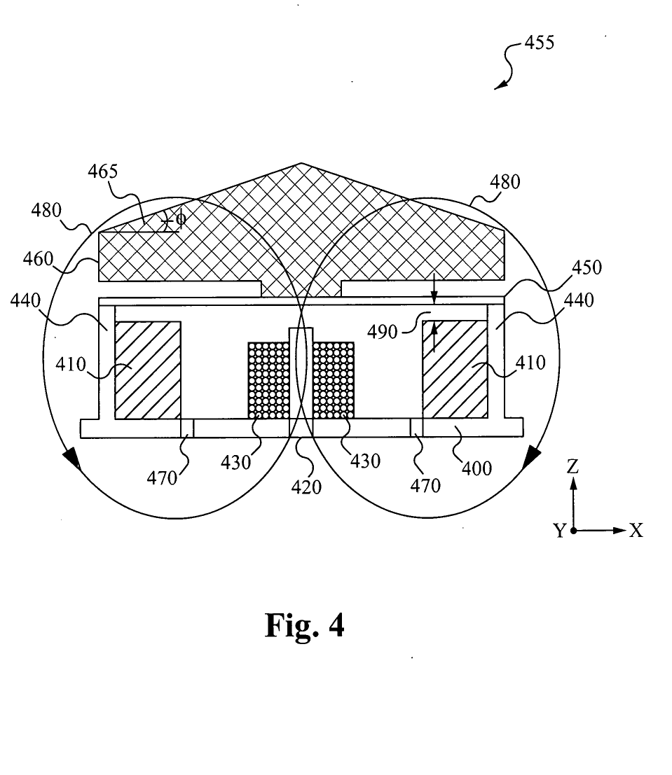

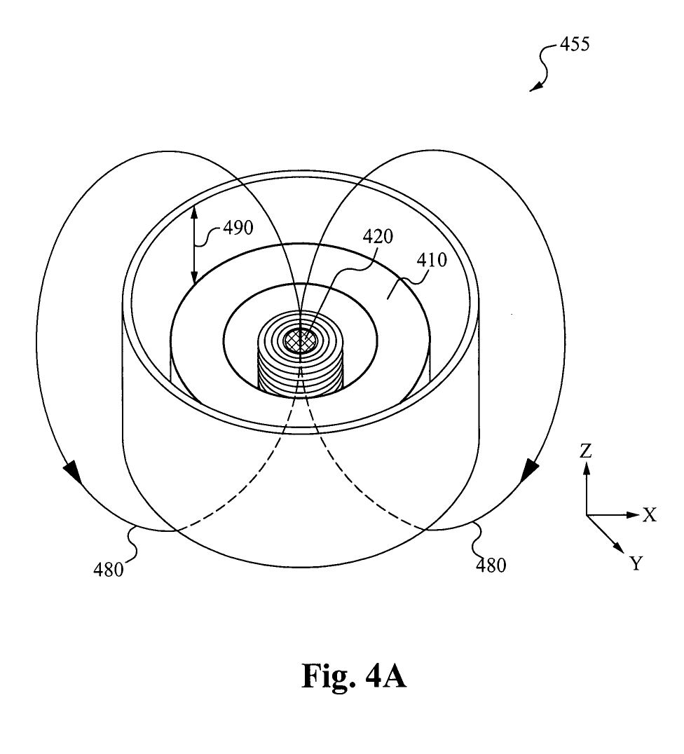

FIG. 4 shows a cross section of the preferred embodiment of the current invention. A simple, low power transducer 455 is sufficiently small for portable applications and is capable of faithfully reproducing electronic signals as mechanical vibrations. The transducer comprises a baseplate 400 on which a ring magnet 410 is mounted. The ring magnet forms a static magnetic field 480 having a center. The baseplate 400 can be of any sturdy construction such as metal or plastic such as polycarbonate. Preferably, the baseplate is constructed of a magnetically saturable material, such as a ferric metal. Preferably, a winding core 420 is mounted on the baseplate substantially in the middle of the ring magnet 410. Preferably, the ring magnet 410 and winding core 420 rise substantially the same height from the baseplate 400. The transducer further preferably comprises a winding 430 around the winding core 420 mounted substantially in the center of the static magnetic field 480. The winding 430 preferably has two terminals (not shown) to which electronic signals can be coupled. Preferably, the terminals should be in electronic communication with a source of electronic signals. The transducer further preferably comprises a cylindrical casing 440 mounted around the ring magnet and mounted to the baseplate. Alternatively, the cylindrical casing 440 and the baseplate 400 can be integrally formed. Preferably, a thin film 450 is coupled to cap the cylindrical casing. The thin film 450 is preferably a bendable metal such as aluminum. Alternatively, the thin film can be plastic, or any other material that can flex. Furthermore, a slug 460 is coupled to the thin film casing. The slug is preferably ferric. Alternatively, the slug can be of any material that is affected by magnetism. As an electronic signal passes through the winding 430, a dynamic component is added to the static magnetic field 480 in response to the electronic signal. The magnetic field 480 interacts with the slug 460, causing the energy in the magnetic field 480 to be transferred to the slug 460 as kinetic energy. This energy transfer causes the slug 460 to vibrate in the Z direction according to the electronic signal. As the slug 460 vibrates, the thin film 450 flexes also in the Z direction. Preferably, one or more air vents 470 are formed in the baseplate 400 allowing air to travel in and out of the interior of the transducer 455. Alternatively, the one or more air vents 470 can be formed in the casing 440. When the slug 460 comes in contact with a mass (not shown), it easily transfers the energy, in the form of mechanical vibration, into the mass. For most efficient energy transfer, the slug 460 is preferably formed in a substantially conical shape having an angle Φ 465 relative to the X-Y plane. This configuration allows for highest efficiency because it concentrates the core of the mass in a center line. Furthermore, for a substantially flat audio response, the mass of the slug 460 is preferably a function of the impedance the winding 430. This enables the slug to respond to electronic signals substantially evenly from DC to 20 KHz.

FIG. 4A shows the preferred embodiment of the transducer 455 with the thin film 450 and slug 460 removed. Preferably, there is a gap 490 (FIG. 4) between the ring magnet 410 and the thin film. Since the ring magnet 410 and winding pole 420 are substantially the same height in reference to the baseplate (not shown), the distance between the thin film and the winding pole 420 is substantially the same as the distance between the thin film and the ring magnet 410. This is to allow space for the thin film to deflect in the Z direction as the slug 460 (FIG. 4) vibrates with the magnetic field 480.

In alternate embodiments, a DC bias introduced into the winding 430 can form the static magnetic field 480. Furthermore, the positions of the winding 430 and ring magnet 410 can be interchanged. In another alternate embodiment, the ring magnet can be excluded, causing a lack of any static magnetic field 480, but rather only a dynamic one formed by an electronic signal passing through the winding 430.

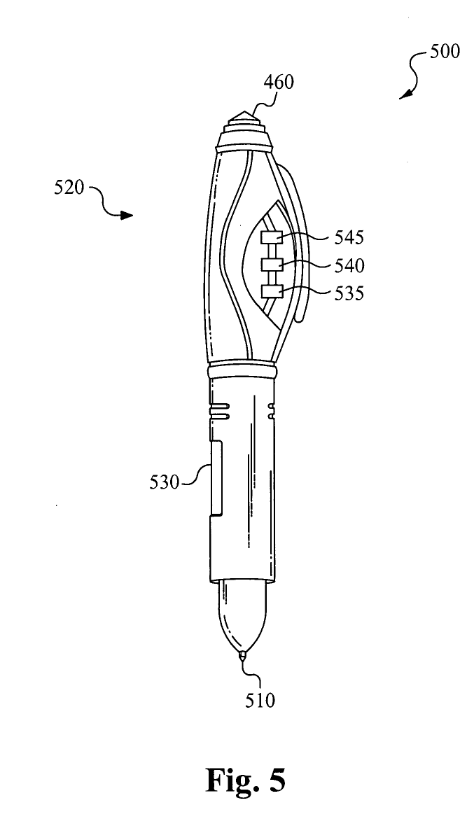

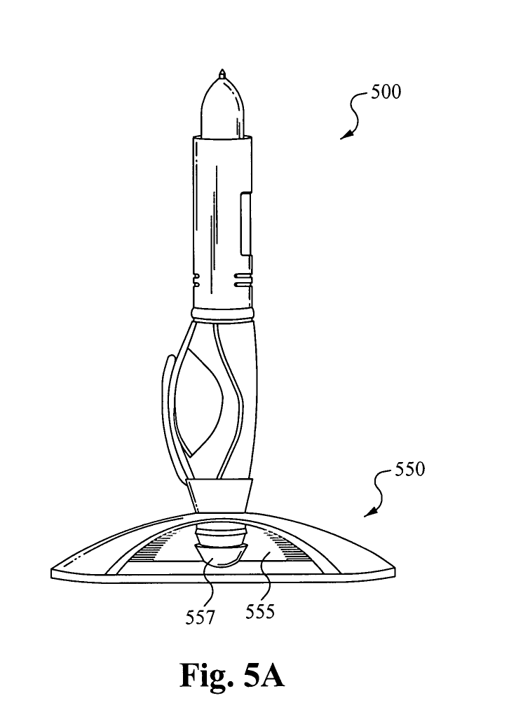

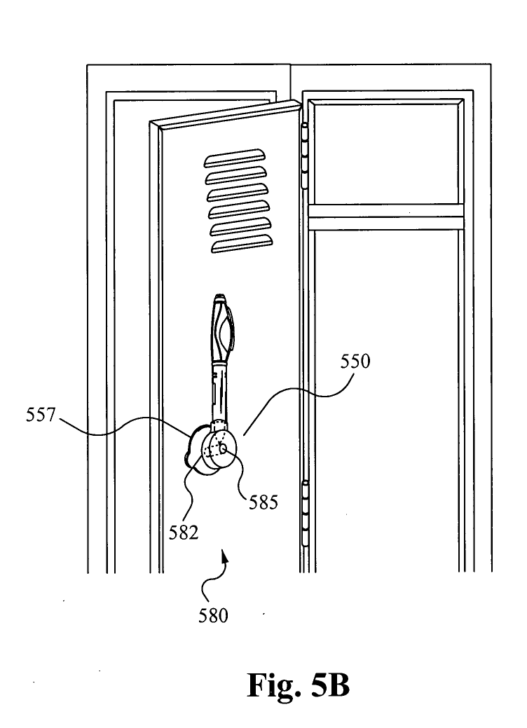

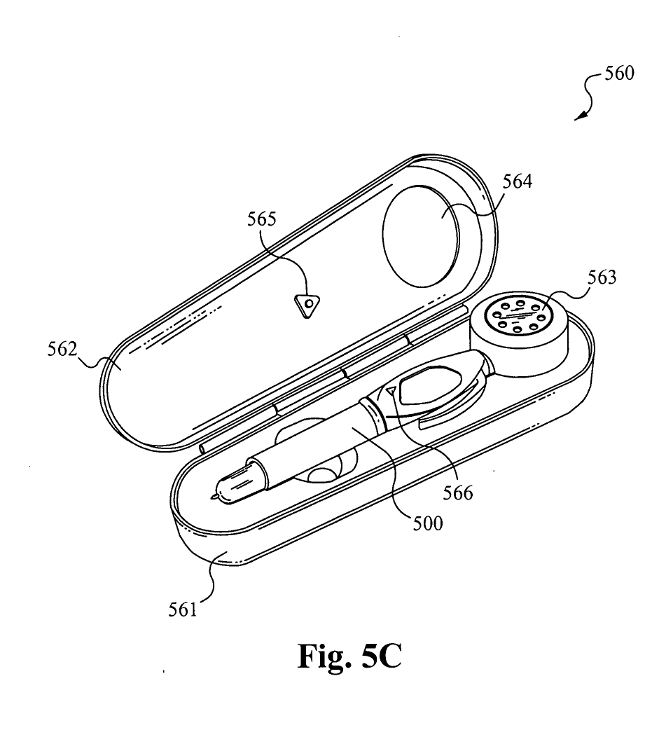

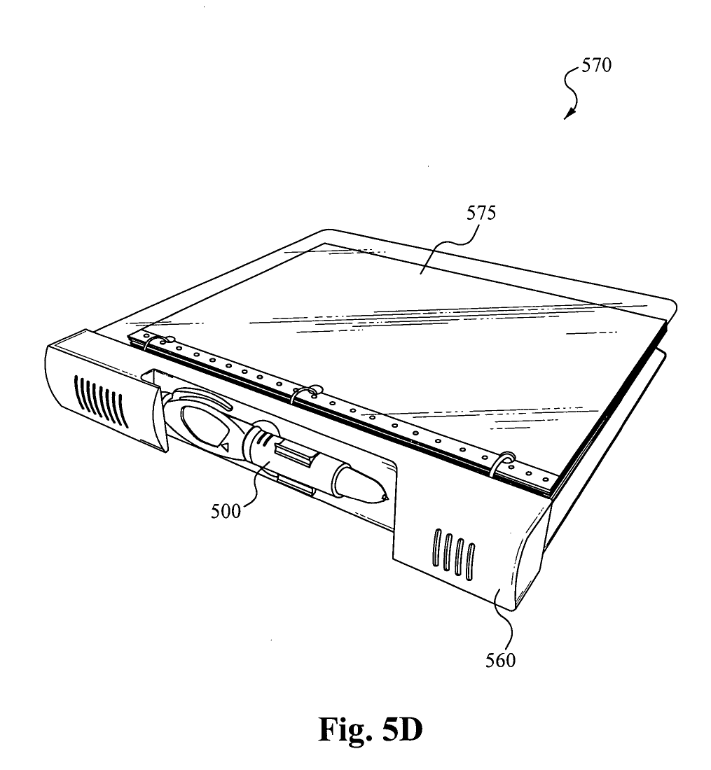

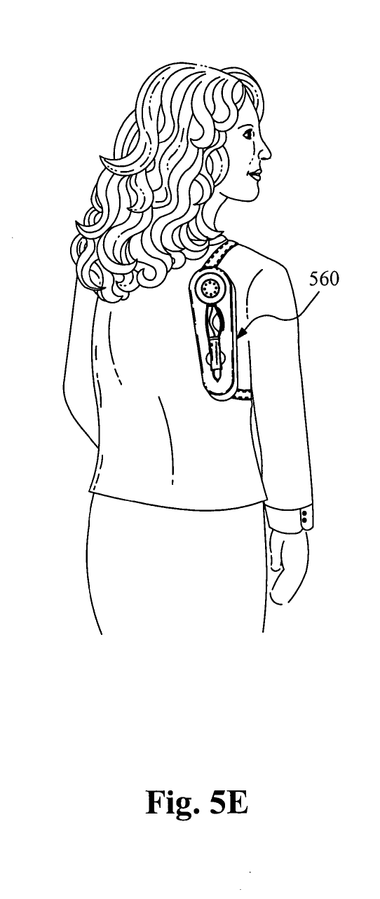

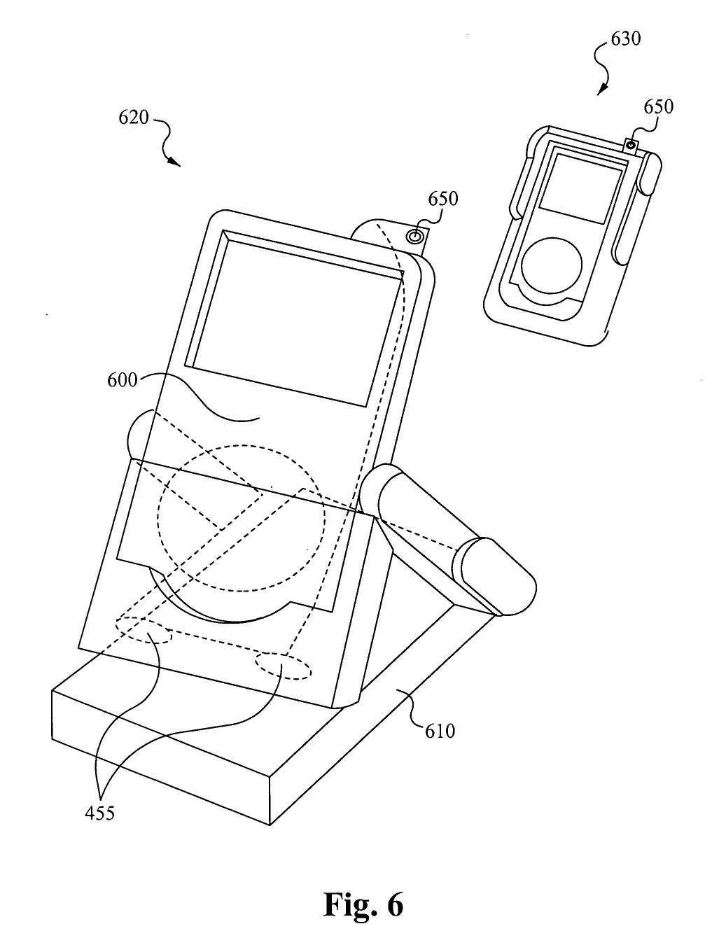

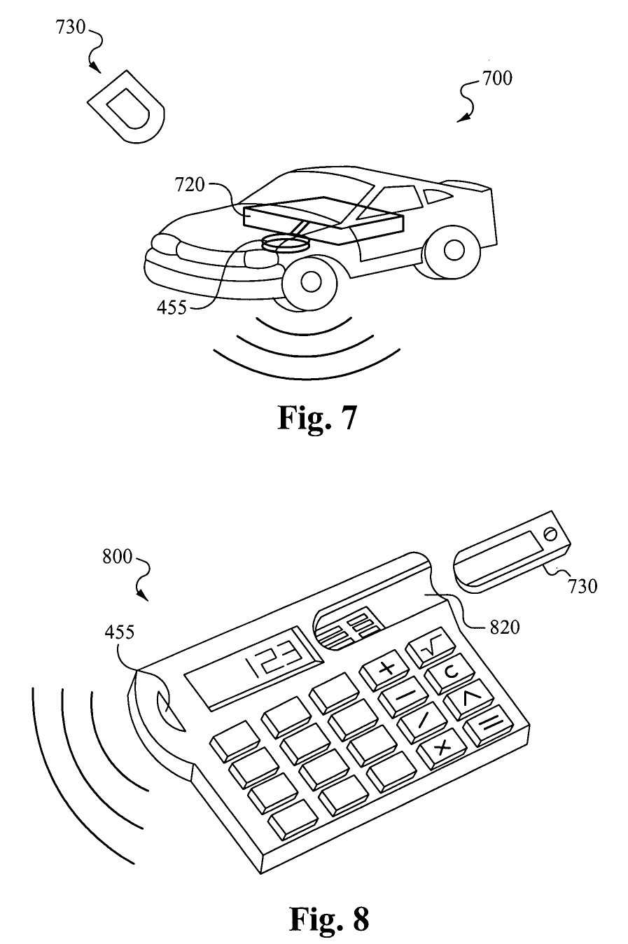

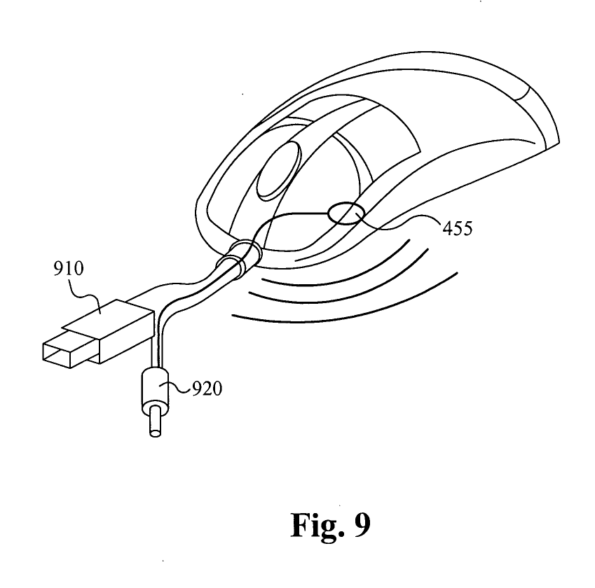

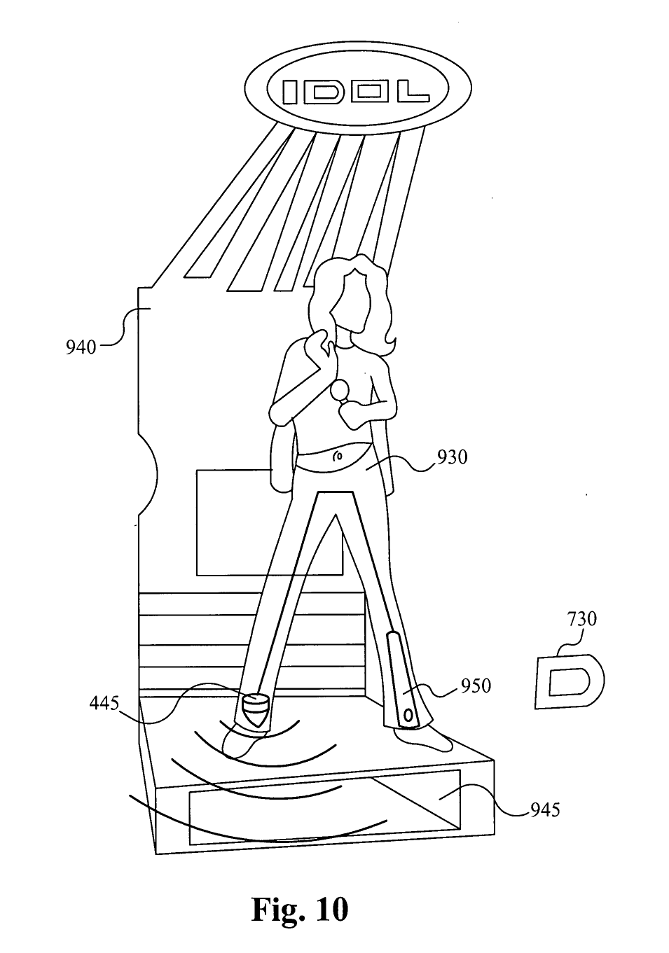

FIG. 5 shows another aspect of the present invention. The transducer (not shown) is mounted inside a pen 500. The pen 500 preferably comprises a writing implement 510 and non writing end 520. Preferably, the transducer is mounted in the non writing end 520, so that the slug 460 can easily come in contact with another object. Alternatively, the transducer can be mounted near the writing implement 510, such that the slug (not shown) comes into mechanical contact with the writing implement to cause vibrations therein while writing. A user (not shown) can download audio files into the pen 500 through a port 530. By way of example, the means to download can be a USB port 530. Alternatively, the pen 500 could have a socket to receive interchangeable FLASH chips. Preferably, the pen further comprises a means to store 535 the audio file as memory such as a FLASH chip, a circuit means to decode 540 the audio file and a circuit means to drive 545 the transducer. By way of example, the audio file could be in mp3 format. Any known or convenient mp3 decoder can be used as a means to decode 540 the audio file. Also by way of example, a pulse width modulator (PWM) can be used as a means to drive 545 the transducer. A PWM is preferable because of its highly efficient load driving characteristics. Preferably, the means to download 530, means to store 535, means to decode 540 and means to drive 545 are all in electrical communication. Alternatively, the means to store 535, means to decode 540 and means to drive 545 can be one chip. Alternatively, the means to store 535, means to decode 540 and means to drive 545 can be externally coupled to a port (not shown). When desired, a user can play an audio file which the pen 500 will convert to vibrations in the slug 460. The non writing end of the pen 520 can be put in physical contact with a surface to transfer mechanical sound energy, causing the surface to resonate and mechanically amplify the vibration. By way of example, if the angle Φ (FIG. 4) of the cone is 20 degrees, the user can roll the pen, and in turn the transducer around 20 degrees and the centerline and moment angle of the slug 460 will always coincide with the surface. The vibration of the surface will cause vibration of the air molecules surrounding that surface which will readily be perceptible to the human ear as sound.

FIG. 5A shows the pen 500 in a holder 550. Preferably, the holder 550 comprises a receptacle 557 configured to receive the non-writing end of the pen 520. More preferably, the holder 550 comprises a hollow resonant chamber 555. When the pen 500 is placed in the holder 550, the slug (not shown) will come into mechanical contact with the receptacle 557. As the slug vibrates according to an audio signal, the slug will transfer kinetic energy in the form of vibration to the receptacle 557 and cause resonance within the resonant chamber 555. The resonance in the resonant chamber will be perceived as sound by the human ear.

FIG. 5B shows another embodiment of the holder. In this embodiment, the holder 550 further comprises a suction cup 582 to suction to a surface such as a locker door 580 common to a gym or school. The receptacle 557 is in mechanical contact with a couple 585 to transfer mechanical vibration to the surface of the locker door. This allows a user to use their locker door as a speaker.

FIG. 5C shows the pen 500 in a case 560. The case 560 preferably comprises a body 561, a hinged lid 562 and cavity (not shown) for receiving the pen 500. The lid can comprise a button 565 for manipulating an on/off switch 566 on the pen 500 when the case is closed. Furthermore, the case 560 preferably comprises a resonant chamber 563. The resonant chamber 563 preferably comprises a receptacle (not shown) configured to receive the non-writing end of the pen 500. As the slug (not shown) vibrates, mechanical sound energy is transferred to the resonant cavity 563 causing mechanical amplification, in turn causing the air molecules surrounding the resonant cavity 563 to vibrate, which will readily be perceptible to the human ear as sound. FIG. 5D shows the case 560 mounted a standard 3 ring binder 570. The binder 570 comprises the case 560 mounted along the binder spine. Alternatively, the case 560 may be mounted on the cover 575. Alternatively, the case 560 may further comprise holes for the straps of a knapsack or backpack (FIG. 5E) so that the user can carry the case 560 close to their shoulder for listening to music without the use of earphones while walking.

In an alternate embodiment, the transducer 455 can be placed in a portable music player 600 as shown in FIG. 6. The portable music player 600 preferably comprises a case 610 shown in its open 620 and closed 630 conditions. In its open condition 620, the case 610 comes into mechanical contact with at least one transducer 455 so that the case acts as a speaker. In its closed condition 630, the at least one transducer 455 can be deactivated and the user can plug in earphones into a jack 650.

In another alternate embodiment, the transducer 455 can be placed in a toy car 700 shown in FIG. 7. Preferably, the transducer 455 is mounted in the toy car 700 such that it can contact a surface, such as a table top, or pre-made track, as transmit vibrations through mechanical contact. The transducer 455 can be powered and controlled through electronics and batteries 720 mounted inside the toy car 700 to play the sounds of a roaring engine and squealing tires. Alternatively, the electronics 720 can be configured to couple to a computer to download music files or receive interchangeable music chips 730. Furthermore, secondary transducers can be mounted on other surfaces of the toy car 700 to simulate sounds of collisions.

In another alternate embodiment, the transducer 455 can be mounted in a calculator or clock 800 as shown in FIG. 8. The calculator or clock 800 can comprise a slot 820 to receive interchangeable music storage chips 730. Preferably, the transducer 455 is mounted such that it can easily come into mechanical contact with a surface, such as a table top.

In another alternate embodiment, the transducer 455 can be mounted in a computer mouse 900 or joystick as shown in FIG. 9. The transducer can receive an electric signal through a computer connector such as a USB connector 910, or a separate audio jack 920, or both. By way of example, the transducer can enhance computer game play by transmitting game sounds as mechanical vibrations into a surface such as a desk. Alternatively, the mouse 900 can transmit sound vibrations into a surface, such as a desk, when the user receives an email, or makes a spelling mistake while typing.

In another exemplary embodiment, an action figure or a doll 930 can have the transducer 455 mounted therein. The doll can be removably mounted to a stand 940 comprising a resonant chamber 945. The transducer 455 is preferably mounted such that it can easily come into mechanical contact with the resonant chamber 945. Preferably, the doll can speak predetermined phrases or play the theme song of an action figure. Alternatively, the doll 930 can comprise a slot 950 to connect to a computer to download music. Alternatively, the slot can be configured to receive interchangeable music chips 730.

Many of the embodiments shown and described in the various figures can be interchanged to achieve the desired results, and this description should be read to encompass such interchange as well. As such, references herein to specific embodiments and details thereof are not intended to limit the scope of the claims appended hereto. It will be apparent to those skilled in the art that modifications can be made to the embodiments chosen for illustration without departing from the spirit and scope of the application.

We claim:

1. An apparatus for converting an electronic signal into a mechanical vibration, the apparatus comprising:
a. means for forming a dynamic magnetic field in response to the electronic signal;
b. a mass mounted within the dynamic magnetic field, wherein the mass is operatively acted upon by the dynamic magnetic field such that the mass vibrates according to the dynamic magnetic field.

2. The apparatus in claim 1 wherein the mass comprises a ferric material.

3. The apparatus in claim 1 wherein the means for forming a dynamic magnetic field is a winding wound around a core, wherein the winding is coupled to the electronic signal.

4. The apparatus in claim 1 further comprising means for forming a static magnetic field having a center.

5. The apparatus in claim 4 wherein the means for forming a static magnetic field and the means for forming a dynamic magnetic field are rigidly mounted to a baseplate.

6. The apparatus in claim 4 wherein the means for forming a dynamic magnetic field is mounted within the static magnetic field.

7. The apparatus in claim 4 wherein the means for forming static magnetic field is mounted within the means for forming a dynamic magnetic field.

8. The apparatus in claim 4 where the means for forming a static magnetic field is a ring magnet.

9. A transducer, comprising:
a. a baseplate;
b. a ring magnet mounted on the baseplate;
c. a winding pole mounted on the baseplate substantially in the center of the ring magnet;
d. a winding around the winding pole, having terminals;
e. a casing mounted to the baseplate, wherein the casing encompasses the ring magnet;
f. a film mounted on the casing; and,
g. a slug mounted on the film.

10. The transducer in claim 9, wherein the slug comprises a magnetically saturable substance.

11. The transducer in claim 9, wherein the thin film comprises a magnetically saturable substance.

12. The transducer in claim 9, wherein the slug has a mass, wherein the mass is a function of an impedance of the winding.

13. The transducer in claim 9, wherein the winding has a number of turns, wherein the mass of the slug is a function of the number of turns of the winding.

14. The transducer in claim 9 wherein the ring magnet is a ceramic magnet.

15. The transducer in claim 9 wherein the ring magnet is a neodymium magnet.

16. The transducer in claim 9 wherein the ring magnet is a ferric magnet.

17. The transducer in claim 9 wherein the slug is configured for optimal audio performance.

18. The transducer in claim 9 wherein the slug is of a substantially conical shape.

19. The transducer in claim 9 further having a frequency response, wherein the frequency response is flat across the audio band.

20. A method of converting an analog signal into a mechanical vibration; the method comprising the steps of:
a. forming a static magnetic field having a center;
b. presenting an analog signal to a winding around a winding core, wherein the winding core is located substantially in the center of the static magnetic field; thereby forming a dynamic magnetic field;
c. placing a ferric slug proximal to the dynamic magnetic field; causing the ferric slug to vibrate according to the dynamic magnetic field;
d. putting the ferric slug in mechanical contact with a mass; thereby transferring vibration to the mass.

21. The method in claim 20 wherein the static magnetic field is formed by a ring magnet.

22. The method in claim 20 wherein the ring magnet is a ceramic ring magnet.

23. The method in claim 20 wherein the ring magnet is a neodymium ring magnet.

24. The method in claim 20 wherein the ring magnet is a ferric magnet.

25. A pen, comprising:
a. means for storing data;
b. means for decoding data to form an electronic signal;
c. means for converting the electronic signal into corresponding mechanical vibration, wherein the means for converting is configured to have a substantially flat audio response.

26. The pen in claim 25, wherein the means for storing data is configured to store audio files.

27. The pen in claim 25, wherein the electronic signal is an audio signal.

28. The pen in claim 25, further comprising means for downloading data from an external source.

29. The pen in claim 25, wherein the means for storing data is interchangeable.

30. The pen in claim 25, wherein the means for decoding comprises a PWM driver.

31. The pen in claim 25, having a writing end and a non writing end, wherein the means for converting is located substantially at the non writing end.

32. The pen in claim 25, having a writing end and a non writing end, wherein the means for converting is located substantially at the writing end.

33. The pen in claim 25, wherein the means for converting is a transducer, wherein:
a. the transducer is configured to convert the electronic signals into mechanical vibration;
b. the transducer is configured have a frequency response that is substantially flat across the audio band.

34. The pen in claim 25, wherein the pen further comprises a holder.

35. The holder in claim 34, wherein the holder further comprises a resonant cavity.

36. The holder in claim 34, wherein the holder further comprises a suction cup.

37. The pen in claim 25, wherein the pen further comprises a case, wherein the case comprises:
a. a cavity for receiving the pen;
b. a resonant chamber, configured to be in mechanical contact with the means for converting.

38. The pen in claim 37, wherein the case further comprises a binder.

39. The pen in claim 37 wherein the case is coupled to a backpack.

40. A portable music player, the portable music player comprising:
a. a case, wherein the case can be in one of an open or closed state, the case comprising a resonant chamber;
b. at least one means for converting an electronic signal into mechanical vibration; wherein the at least one means for converting is configured for a flat response across the audio band; further wherein the means for converting is configured to come into physical contact with the resonant chamber.

41. A toy car, the toy car comprising at least one means for converting an electronic signal into mechanical vibration; wherein the at least one means for converting is configured for a flat response across the audio band; wherein the at least one means for converting is configured to come into contact with a surface.

42. A doll, the doll comprising:
a. at least one means for converting an electronic signal into mechanical vibration; and
b. a stand, to which the doll can be coupled, comprising a resonant chamber, wherein the means for converting comes in contact with the resonant chamber upon coupling of the doll and the stand.

43. The doll according to claim 42, wherein the at least one means for converting is configured for a flat response across the audio band, and further wherein the at least one means for converting is configured to come into contact with a surface.

44. A computer interface device, comprising at least one means for converting an audio signal into mechanical vibration; wherein the at least one means for converting is configured for a flat response across the audio band, wherein the means for converting is configured to come into contact with a surface on which the computer interface device sits.

45. The computer interface device in claim 44, wherein the computer interface device comprises a computer mouse.

46. The computer interface device in claim 44, wherein the computer interface device comprises a joystick.

47. A calculator, comprising at least one means for converting an electronic signal into mechanical vibration; wherein the at least one means for converting is configured for a flat response across the audio band, wherein the means for converting is configured to come into contact with a surface on which the calculator device sits.
